(19) United States
(12) Patent Application Publication
(10) Pub. No.: US 2014/0161419 A1
(43) Pub. Date: Jun. 12, 2014

(54) PLAYBACK APPARATUS, PLAYBACK METHOD, AND PROGRAM

(71) Applicants: Koji Fukui, Chiba (JP); Kensuke Oonuma, Tokyo (JP)

(72) Inventors: Koji Fukui, Chiba (JP); Kensuke Oonuma, Tokyo (JP)

(73) Assignee: SONY CORPORATION, Tokyo (JP)

(21) Appl. No.: 14/232,019

(22) PCT Filed: Jul. 11, 2012
(86) PCT No.: PCT/JP2012/067714

§ 371 Date: Jan. 10, 2014

(30) Foreign Application Priority Data
Jul. 19, 2011 (JP) 2011-157851

(51) Int. Cl. H04N 5/91

(52) U.S. Cl. CPC H04N 5/91
USPC 386/248

(57) ABSTRACT

The present technique relates to a playback apparatus, a playback method, and a program which can perform loop playback of video images while continuing outputting a sound.

The present technique has a playback unit which plays back a first stream and a second stream out of synchronization, a first stream has a first browsing unit and a second browsing unit, and a second browsing unit is a browsing unit which includes part of the first browsing unit. Further, the playback unit performs a control to play back the second browsing unit after playing back the first browsing unit, and make a transition to playback from a top of the first browsing unit after playing back the second browsing unit. The present technique is applicable to a blue-ray disk player.

### TECHNICAL FIELD

The present technique relates to a playback apparatus, a playback method, and a program. More specifically, the present technique relates to a playback apparatus, a playback method, and a program which continuously playback predetermined video images.

### BACKGROUND ART

When, for example, a movie recorded in a DVD (Digital Versatile Disc) is played back, playback as illustrated in FIG. 1 is performed. Referring to FIG. 1, playback is sometimes performed such that a video image A jumps to a video image B, the video image B jumps to a video image C, the video image C jumps to a video image D and the video image D jumps to a video image E. For example, one movie recorded in, for example, a DVD has a plurality of chapters, and a jump is sometimes performed from a predetermined chapter to another chapter.

Upon such playback, the video image A has a corresponding voice A, the video image B has a corresponding voice B, the video image C has a corresponding voice C, the video image D has a corresponding voice D and the video image E has a corresponding voice E. When playback as illustrated in FIG. 1 is performed, if a jump is performed from a predetermined video image to another video image, a jump is simultaneously performed from a predetermined voice to another voice. Thus, in case of such playback, playback is performed with interrupted voices.

Further, there is also a function called slide show which continuously plays back recorded still images by sequentially switching the still images. There is also a function of playing back the images together with voices when this slide show is executed. In such slide show, the voices are used as BGM (Background music). Upon this slide show, even when still images are switched, the still images are played back while voices are not switched, and therefore playback is performed with uninterrupted voices.

This slide show is applicable to video images. For example, there is browsable slide show among standards of a Blu-ray (trademark) (referred to as Blu-ray below) disc. This browsable slide show is a standard which can independently play back voices and video images like the above continuous playback of still images and switch video images while emitting sounds. According to this browsable slide show, it is possible to browse video images with BGMs.

Upon browsable slide show, playback is performed as illustrated in FIG. 2. Similar to FIG. 1, playback illustrated in FIG. 2 is performed such that the video image A jumps to the video image B, the video image B jumps to the video image C, the video image C jumps to the video image D and the video image D jumps to the video image. Upon the browsable slide show, video images and voices are independently played back, so that, as illustrated in FIG. 2, the voice A which is irrelevant to the video images A to E is played back as a voice.

Upon browsable slide show, video images can be switched by a user's operation, and, when, for example, a command to switch the video image A to the video image B is given, playback is continued while a playback position of the voice A does not jump, so that playback is performed with the uninterrupted voice A. (See, for example, Patent Document 1)

### CITATION LIST

### Patent Document

Patent Document 1: JP 2005-317172 A

### SUMMARY OF THE INVENTION

### Problems to be Solved by the Invention

As described with reference to FIG. 1, a jump can be performed at a specified time in case of a normal movie instead of browsable slide show, so that it is possible to perform loop playback of the movie. When, for example, the video image A is repeatedly played back, and the video image A is finished, by specifying a time of a top of the video image A, performing a jump at the time of the top of the video image A and starting playing back the video image A again, loop playback is performed. Such loop playback is used in a menu screen of a movie when, for example, the movie is recorded in a DVD.

However, a video image and a voice synchronize in the normal image described with reference to FIG. 1, and therefore when a video image jumps according to a user's operation, the voice also jumps and playback is performed with interrupted voices.

A case where loop playback of a movie is performed using the browsable slide show described with reference to FIG. 2 will be considered again. In FIG. 2, the video images A to E are referred to as browsing units. The browsing unit is a unit at which a video image is switched. For example, one picture configures one browsing unit in some cases.

Although, when playback of the last browsing unit is finished according to the Blu-ray standard, making a setting to temporarily stop video images or move to a next browsing unit is designated, performing loop playback in one browsing unit is not designated. In other words, when playback of the last browsing unit is finished, returning to a top of the same browsing unit and starting playback again are not designated.

Such loop playback of the same browsing unit may be controlled and realized using a program such as BD-J (Blu-ray Disc Java (registered trademark)). However, when, for example, a jump is performed to the same browsing unit by way of a browsing unit specified jump, starting playback from the top of the browsing unit is not guaranteed. According to the Blu-ray standard, a detailed behavior is not defined, and therefore a behavior is likely to be different depending on an implementing method on the player side. When, for example, a jump to the same browsing unit is commanded, there is a player which does not make any behavior or a player which starts playback not from the top but from the middle and behaviors are different between players, and therefore it is not possible to guarantee loop playback as a result.

According to still another method, it is also possible to command a jump to the top of a browsing unit by way of a time specified jump. However, according to the Blu-ray standard, a jump may not be performed at a right accurate time, and therefore, a jump is performed to a neighboring browsing unit depending on a player, and therefore, it is not possible to guarantee loop playback as described above.

The present technique is made in light of this situation, and independently plays back images and voices and performs loop playback of images.

### Solutions to Problems

A playback apparatus according to one aspect of the present technique has a playback unit which plays back a first stream and a second stream out of synchronization, and the first stream has a first browsing unit and a second browsing unit, the second browsing unit is a browsing unit which includes part of the first browsing unit and the playback unit plays back the second browsing unit after playing back the first browsing unit, and makes a transition to playback from a top of the first browsing unit after playing back the second browsing unit.

The first stream may be a video image, and the second stream may be a sound.

The first browsing unit may be a browsing unit which is a loop playback target, and the second browsing unit may be a loop playback browsing unit.

A still mode of a play item for playing back the first browsing unit may be set to a mode which commands a transition to a next play item, and the playback unit may make a transition to playback of the first browsing unit when detecting a transition of playback from the first browsing unit to the second browsing unit.

A still mode of a play item for playing back the first browsing unit may be set to a mode which commands temporary stop, and the playback unit may make a transition to playback of the second browsing unit when detecting that playback of the first browsing unit is finished and a state of temporary stop starts, and make a transition to playback of the first browsing unit when detecting a transition to playback of the second browsing unit.

The first browsing unit may be one browsing unit of a plurality of browsing units which is a loop playback target, and the second browsing unit may be a loop playback browsing unit which is commonly used by the plurality of browsing units.

A playback method according to one aspect of the present technique is a playback method of a playback apparatus which has a playback unit which plays back a predetermined stream, and a first stream has a first browsing unit and a second browsing unit, the second browsing unit is a browsing unit which includes part of the first browsing unit and the playback method includes the steps of, at the playback unit, playing back the first stream and a second stream out of synchronization, and playing back the second browsing unit after playing back the first browsing unit, and making a transition to playback from a top of the first browsing unit after playing back the second browsing unit.

A program according to the present technique is a computer-readable program, and a first stream has a first browsing unit and a second browsing unit, the second browsing unit is a browsing unit which includes part of the first browsing unit and the program causes a computer which controls a playback apparatus which has a playback unit which plays back a predetermined stream to execute processing including the steps of, at the playback unit, playing back the first stream and a second stream out of synchronization, and playing back the second browsing unit after playing back the first browsing unit, and making a transition to playback from a top of the first browsing unit after playing back the second browsing unit.

With the playback apparatus, the playback method and the program according to one aspect of the present technique, the first stream includes a first browsing unit and a second browsing unit, and the second browsing unit is a browsing unit which includes part of the first browsing unit. Upon playback, the first stream and the second stream are played back out of synchronization, the second browsing unit is played back after the first browsing unit is played back and a transition is made to playback from the top of the first browsing unit after the second browsing unit is played back.

### Effects of the Invention

According to one aspect of the present technique, it is possible to independently play back images and voices and perform loop playback of images.

### BRIEF DESCRIPTION OF DRAWINGS

FIG. 1 is a view for explaining a relationship between skip playback of a video image and a voice.

FIG. 2 is a view for explaining a relationship between skip playback of a video image and a voice.

FIG. 3 is a view illustrating a configuration of a playback apparatus according to one embodiment.

FIG. 4 is a view for explaining a structure of a playlist.

FIG. 5 is a view for explaining a structure of a playlist.

FIG. 6 is a view for explaining a structure of clip information.

FIG. 7 is a view for explaining a structure of clip information.

FIG. 8 is a view for explaining a configuration of a video stream.

FIG. 9 is a view for explaining a loop playback browsing unit.

FIG. 10 is a flowchart for explaining processing upon loop playback.

FIG. 11 is a view for explaining another configuration of a play item.

FIG. 12 is a flowchart for explaining processing upon loop playback.

FIG. 13 is a view for explaining another configuration of a loop playback play item.

FIG. 14 is a view for explaining a loop playback browsing unit.

FIG. 15 is a view for explaining a recording medium.

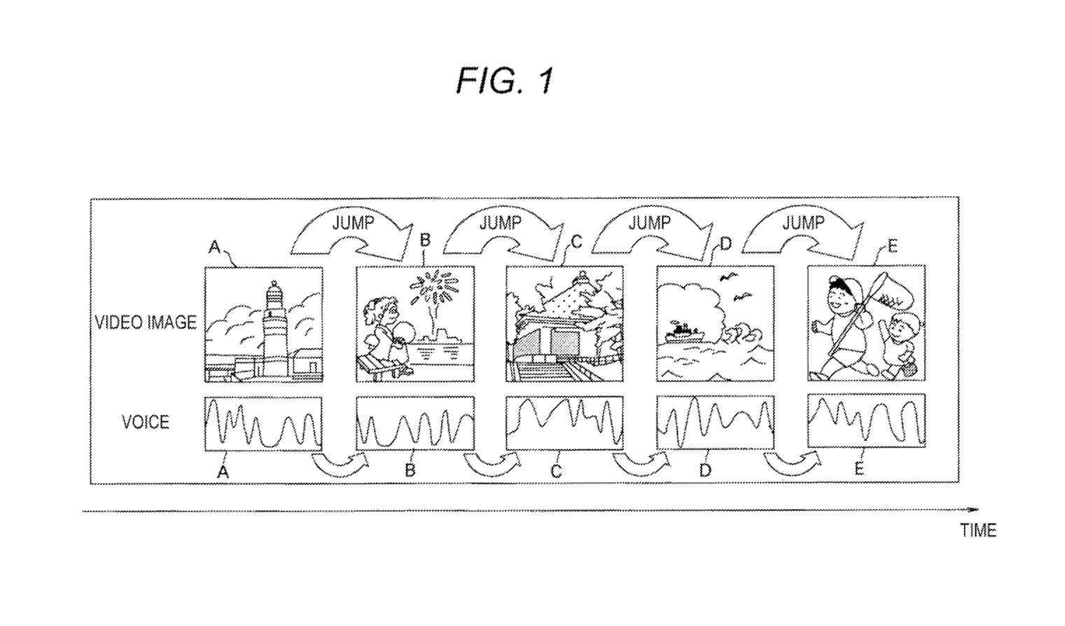

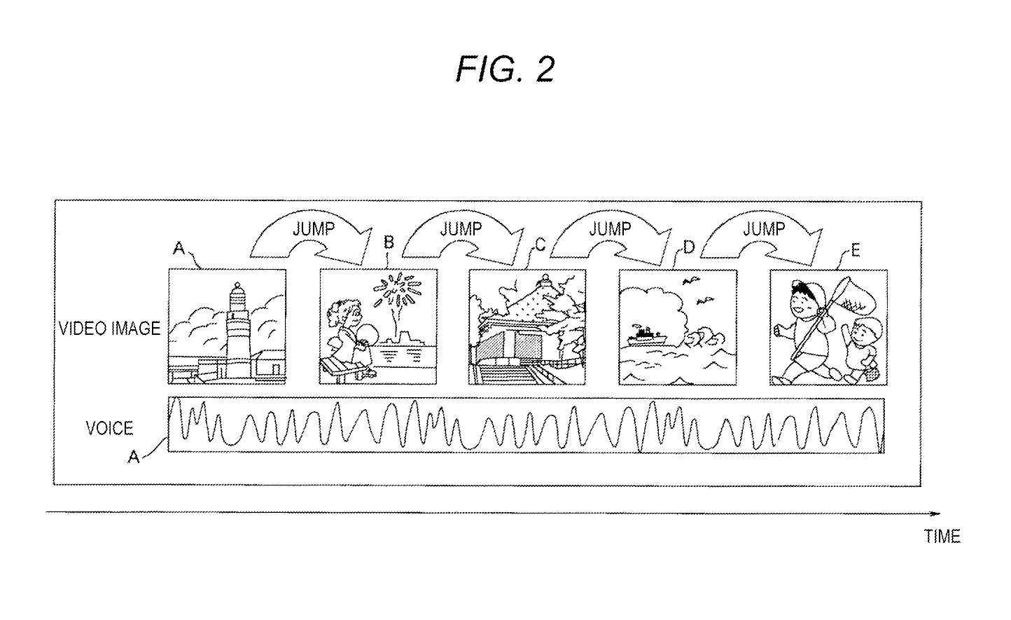

### MODE FOR CARRYING OUT THE INVENTION

An embodiment of the present technique will be described below with reference to the drawings.

[Configuration of Playback Apparatus]

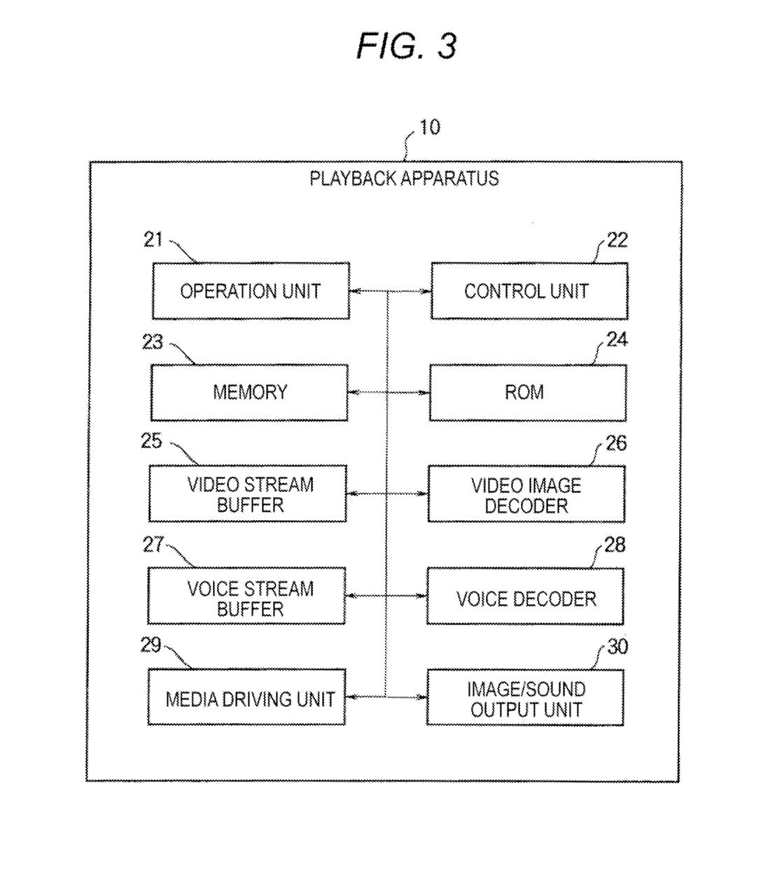

FIG. 3 is a view illustrating a configuration of a playback apparatus to which the present technique is applied according to one embodiment. A playback apparatus 10 illustrated in FIG. 3 is applicable to a blu-ray disc player or a blu-ray disc recorder.

Hereinafter, the playback apparatus 10 which plays back a blu-ray disc will be described. The playback apparatus 10 illustrated in FIG. 3 has an operation unit 21, a control unit 22, a memory 23, a ROM 24, a video stream buffer 25, a video image decoder 26, a voice stream buffer 27, a voice decoder 28, a medium driving unit 29 and an image/sound output unit 30.

The operation unit 21 is a unit which receives a command from a user, and employs a configuration including a plurality of buttons and a receiving unit (not illustrated) which receives a signal from a remote controller. The control unit 22 controls each unit in the playback apparatus 10. The memory 23 stores stream structure information and a control program read from a predetermined recording medium (for example, a blu-ray disc) driven by the medium driving unit 29. The ROM 24 stores a program which causes the control unit 22 to perform control.

The video stream buffer 25 temporarily stores a video stream read from a recording medium driven by the medium driving unit 29, and supplies the video stream to the video image decoder 26. The video image decoder 26 decodes the video stream supplied from the video stream buffer 25 by a predetermined method, and supplies the video stream to the image/sound output unit 30. Similarly, the voice stream is read from the recording medium driven by the medium driving unit 20, is temporarily stored in the voice stream buffer 27, is decoded by the voice decoder 28 and is supplied to the image/sound output unit 30.

The image/sound output unit 30 supplies video images and voices to an external device which is not illustrated such as a television receiver. As described above, the medium driving unit 29 drives a predetermined recording medium, and reads, for example, a video stream, a voice stream, stream structure information and a control program from the recording medium. In addition, although a voice will be described, a sound or music other than a human voice is also included.

[File Structure]

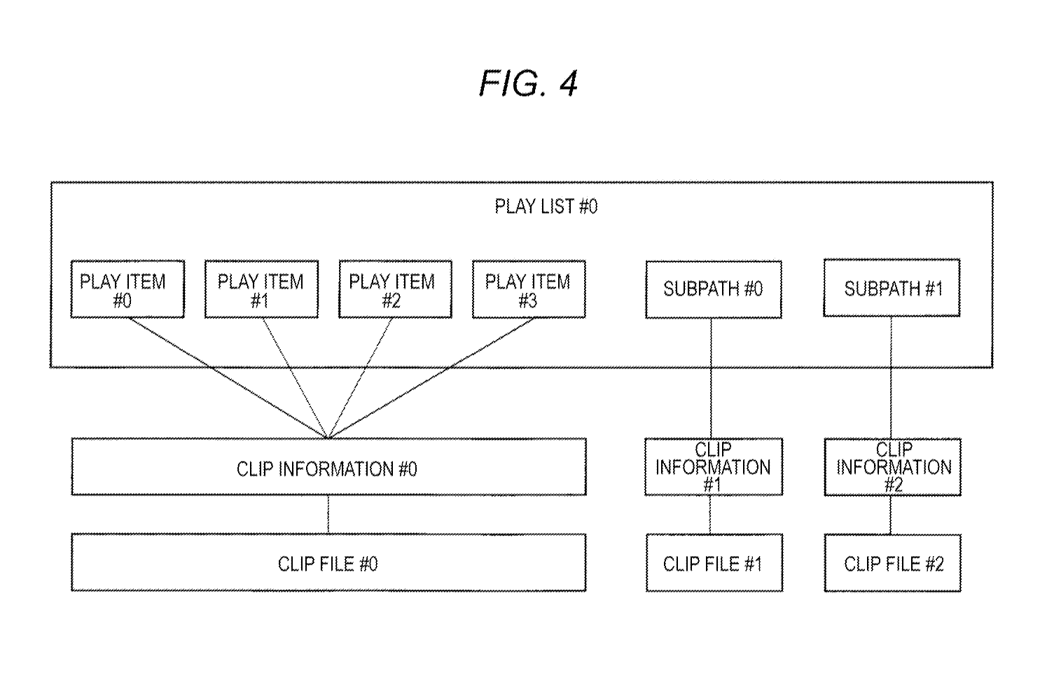

Files handled by the playback apparatus 10 will be described with reference to FIG. 4. A playlist #0 includes a play item #0, a play item #1, a play item #2, a play item #3, a subpath #0 and a subpath #1. The playlist #0 is a collection of sections which the user desires to playback and sets among clips. A clip file is a movie or voice stream, and, for example, a MPEG2 or AVC movie or a linear PCM or Dolby digital (trademark) voice is multiplexed in a MPEG2-TS format.

In the following description, a configuration related to browsable slide show will be described. Upon browsable slide show, video images and voices are independently played back. A clip file of a video image which is independently played back is the clip file #0, and clip files of a voice are the clip files #1 and the clip files #2.

In clip information, information of a clip file such as a format is written. Information of the clip file #0 is written in clip information #0, information of the clip file #1 is written in clip information #1 and information of the clip file #2 is written in clip information #2.

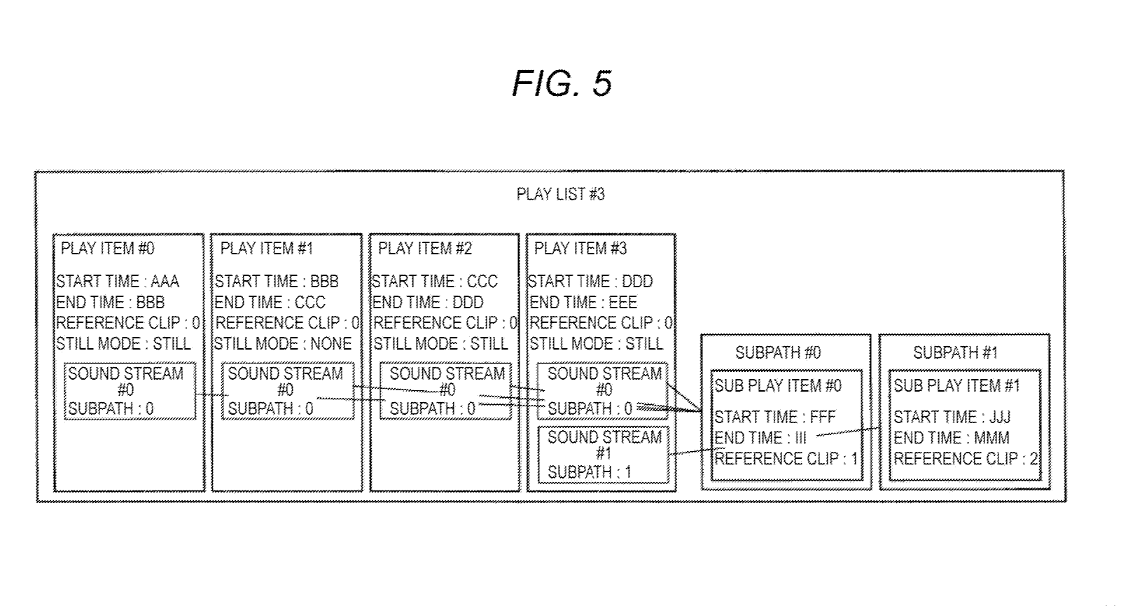

In case of browsable slide show, video and voice clip files are separated as described above. Further, a clip of a video image is referred to from a play item of a playlist. As described below with reference to FIG. 5, a configuration is employed where a video image is switched when a play item which the user wants to play back is selected, and a configuration is employed where a clip of a voice is referred to from sub play items of subpaths of a playlist. Further, a configuration is also employed where a voice is switched when a voice stream which the user wants to play back is selected.

In an example illustrated in FIG. 4, a structure in which three video images of a still image, a loop movie and a still image can be switched, and a voice is also switched in the last still image is adopted. The structure of this playlist #0 is illustrated in FIG. 5.

In each play item of the play items #0 to #3, information such as a start time, an end time, a reference clip, a still mode, a sound stream and a subpath is described. The start time indicates a playback start time of a clip of each play item, and the end time indicates a playback end time of the clip of each play item.

The reference clip represents information of a clip which each play item refers to. The still mode represents whether or not to transition to playback of a next play item or make temporary stop when playback of each play item is finished. When this still mode is set to “still”, temporary stop is performed and, when the still mode is set to “no”, a transition to playback of a next play item is made.

The start time of the play item #0 is “AAA”, the end time is “BBB” and the reference clip is “0”. Hence, referring to the clip information #0, the clip file #0 is played back from the time “AAA” to the time “BBB”. Further, the still mode is set to “still”, and therefore playback is temporarily stopped at a point of time of the time “BBB”. Furthermore, the sound stream of the play item #0 is a sound stream #0 and a subpath is “0”, and then the subpath #0 is referred to and a sound stream is played back.

Similarly, the start time of the play item #1 is “BBB”, the end time is “CCC” and the reference clip is “0”. Hence, referring to the clip information #0, the clip file #0 is played back from the time “BBB” to the time “CCC”. Further, the still mode is set to “no”, and then a transition to playback of the next play item “2” is made at the point of time of the time “CCC”. Furthermore, the sound stream of the play item #0 is the sound stream #0 and the subpath is “0”, and then the subpath #0 is referred to and a sound stream is played back.

Similarly, the start time of the play item #2 is “CCC”, the end time is “DDD” and the reference clip is “0”. Hence, referring to the clip information #0, the clip file #0 is played back from the time “CCC” to the time “DDD”. Further, the still mode is set to “still”, and therefore playback is temporarily stopped at a point of time of the time “DDD”. Furthermore, the sound stream of the play item #0 is the sound stream #0 and the subpath is “0”, and then the subpath #0 is referred to and a sound stream is played back.

Similarly, the start time of the play item #3 is “DDD”, the end time is “EEE” and the reference clip is “0”. Hence, referring to the clip information #0, the clip file #0 is played back from the time “DDD” to the time “EEE”. Further, the still mode is set to “still”, and therefore playback is temporarily stopped at a point of time of the time “EEE”. Furthermore, the sound stream of the play item #0 is the sound stream #0 and a subpath is “0”, and then the subpath #0 is referred to and a sound stream is played back, or the sound stream is a sound stream #1 and a subpath is “1”, and then a subpath #1 is referred to and a sound stream is played back. The play item #3 is an item from which the sound stream #0 or the sound stream #1 can be selected.

If “#0” is selected as a sound stream of the play item #3, even when any play item of the play items #0 to #3 is played back, the sound stream #0 is played back as the sound stream. Hence, even when playback of the play items #0 to #3 of a video image is sequentially switched, the sound stream is played back without being interrupted.

Although details will be described below, the play item #2 is a play item which is provided to perform loop playback of the play item #1. When this play item #1 is played back and this playback is finished, the still mode is set to “no”, and then a transition to playback of the play item #2 is made. Further, when playback of the play item #2 is finished, a return to playback of the play item #1 is made. Thus, the play item #1 is repeatedly played back.

In the subpath #0 included in the playlist #0, that a sub play item is “a sub play item #0” is described. Further, that a start time of a clip referred to in this subpath #0 is “FFF”, and an end time is “III” is described. Furthermore, that a reference clip referred to in this subpath #0 is “1” is described.

Similarly, in the subpath #1 included in the playlist #1, that a sub play item is “a sub play item #1” is described. Further, that a start time of a clip referred to in this subpath #1 is “JJJ”, and an end time is “MMM” is described. Furthermore, that a reference clip referred to in this subpath #1 is “2” is described.

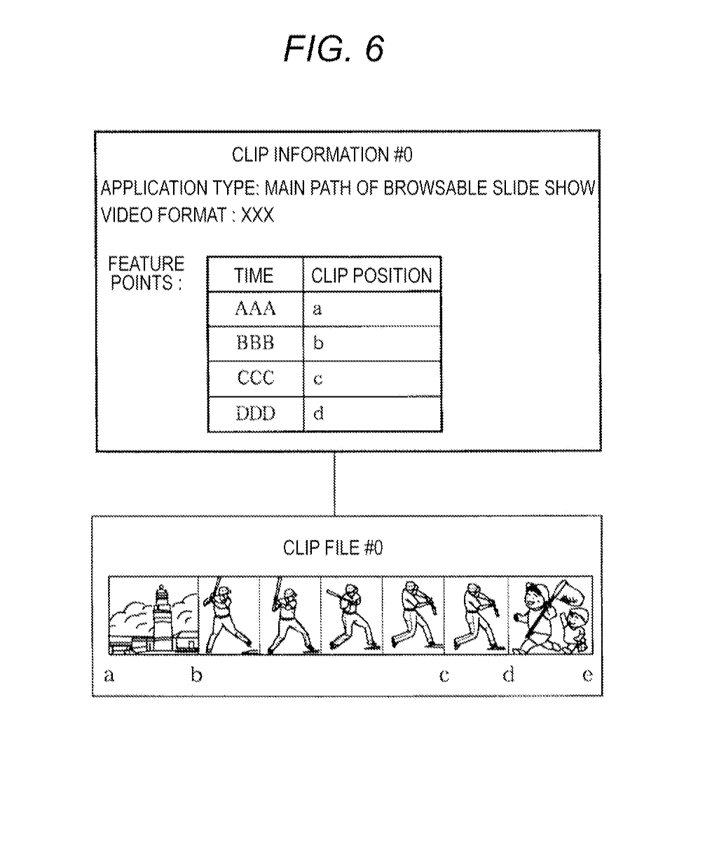

FIG. 6 illustrates a configuration of the clip information #0. In the clip information #0, information of “a main path of browsable slide show” is described as an application type (a type of an application). Further, information of “XXX” is described as a video format. In the information of “XXX”, information such as MPEG or AVC is described. Further, in the clip information #0, information of feature points is also described.

Referring to FIG. 6, as information of these feature points, information indicating that playback is started from a clip position “a” at the time “AAA”, playback is started from a clip position “b” at the time “BBB”, playback is started from a clip position “c” at the time “CCC”, and playback is started from a clip position “d” at the time “DDD” is written. In the clip file #0, video images obtained when playback based on the feature points described in the clip information #0 is performed are illustrated.

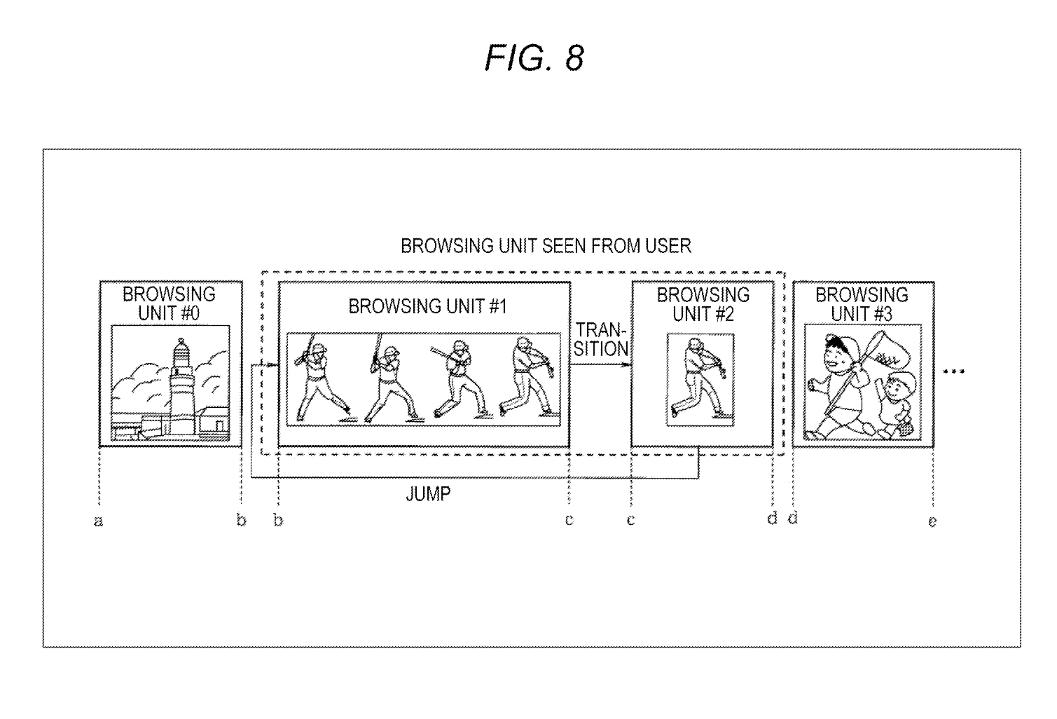

The clip file #0 includes four browsing units corresponding to the play items #0 to #3. The clip positions “a” and “b” are a browsing unit corresponding to the play item #0, the clip positions “b” and “c” are a browsing unit corresponding to the play item #1, the clip positions “c” and “d” are a browsing unit corresponding to the play item #2, and clip positions “d” and “e” are a browsing unit corresponding to the play item #3. Although playback of these browsing units will be described below with reference to FIG. 8, the clip information #1 and the clip information #2 will be described first.

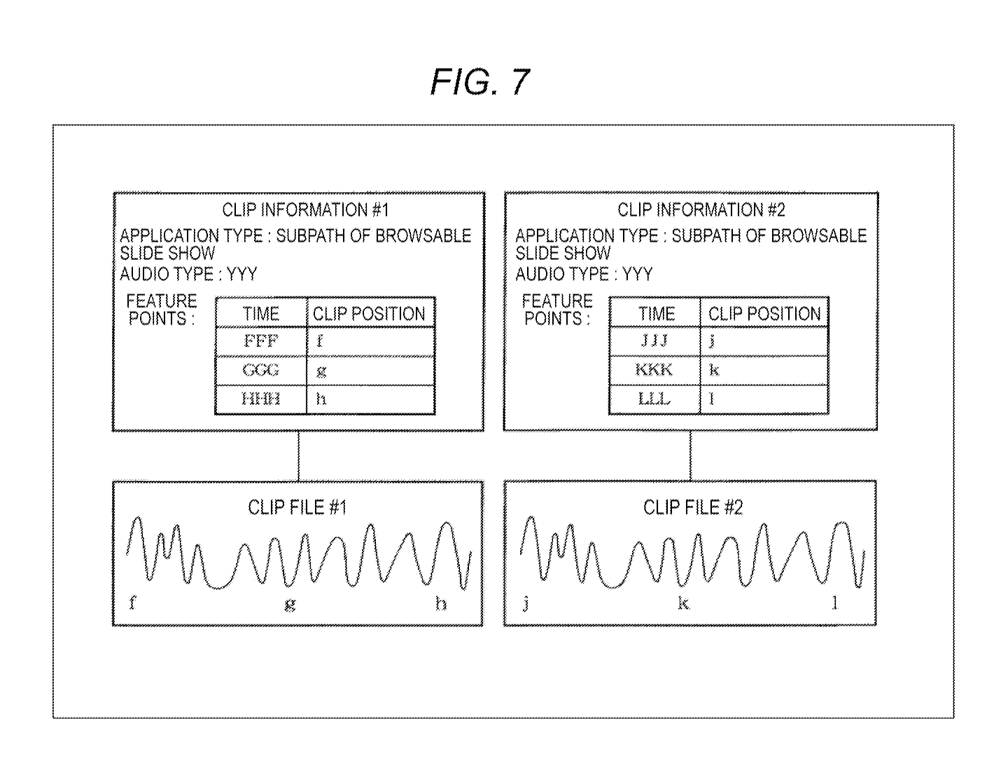

FIG. 7 is a view illustrating a configuration of the clip information #1 and the clip information #2. The clip information #1 and the clip information #2 employ basically the same configuration as that of the clip file #0. In the clip information #1, information of “a subpath of browsable slide show” is described as an application type (a type of an application). Further, information of “YYY” is described as an audio format. In the information of “YYY”, information such as linear PCM is described. Further, in the clip information #1, information of feature points is also described.

Referring to FIG. 7, as information of these feature points, information indicating that playback is started from a clip position “f” at the time “FFF”, playback is started from a clip position “g” at the time “GGG”, and playback is started from a clip position “h” at the time “HHH” is written. In the clip file #1, a voice obtained when playback based on the feature points described in the clip information #1 is performed is illustrated as a pseudo waveform.

Similarly, in the clip information #2, information of “a subpath of browsable slide show” is described as an application type (a type of an application). Further, information of “YYY” and information of the feature points are also described as an audio format.

Referring to FIG. 7, as information of these feature points, information indicating that playback is started from a clip position “j” at the time “JJJ”, playback is started from a clip position “k” at the time “KKK”, and playback is started from a clip position “1” at the time “LLL” is written. In the clip file #2, a voice obtained when playback based on the feature points described in the clip information #2 is performed is illustrated as a pseudo waveform.

In addition, the numbers and configurations of the above playlists, play items, clip information and clip files are exemplary, and are by no means limited thereto. Further, the information described in these is exemplary and other pieces of information are also described.

[Configuration of Video Stream]

A configuration of a video stream will be described with reference to FIG. 8. The video stream illustrated in FIG. 8 is the clip file #0 in FIG. 6. The browsing unit #0 is a browsing unit managed by the play item #0 (FIG. 5), and is played back in the section a-b. The browsing unit #1 is a browsing unit managed by the play item #1 (FIG. 5), and is played back in the section b-c. The browsing unit #2 is a browsing unit managed by the play item #2 (FIG. 5), and is played back in the section c-d. Further, the browsing unit #3 is a browsing unit managed by the play item #3 (FIG. 5), and is played back in the section d-e.

Referring to the play item #1 (FIG. 5) which manages the browsing unit #1, the still mode of the play item #1 is set to “no”. Hence, when playback of the browsing unit #1 is finished at the point of item c, a transition to playback of the browsing unit #2 is made. Further, the browsing unit #2 is played back between the point of time c and the point of time d. When playback of the browsing unit #2 is finished at the point of time d and processing described below is executed, a transition to playback from the top (the point of time b) of the browsing unit #1 is made and the browsing unit #1 is played back again.

The browsing unit #1 and the browsing unit #2 are repeatedly played back, so that loop playback of the browsing unit #1 and the browsing unit #2 is realized. The browsing unit #2 is a copy of a last frame of the browsing unit #1. The browsing unit may be a copy of a plurality of frames. The browsing unit #2 is played back after the browsing unit #1 is played back, so that, although the last frame is displayed twice, the frames are played back like one movie to the user.

Further, a plurality of frames positioned at last portions of the browsing unit #1 may be clipped and a plurality of clipped frames may be used as the browsing unit #2. By so doing, when playback from the browsing unit #1 to the browsing unit #2 is continuously performed, these units are played back like one movie.

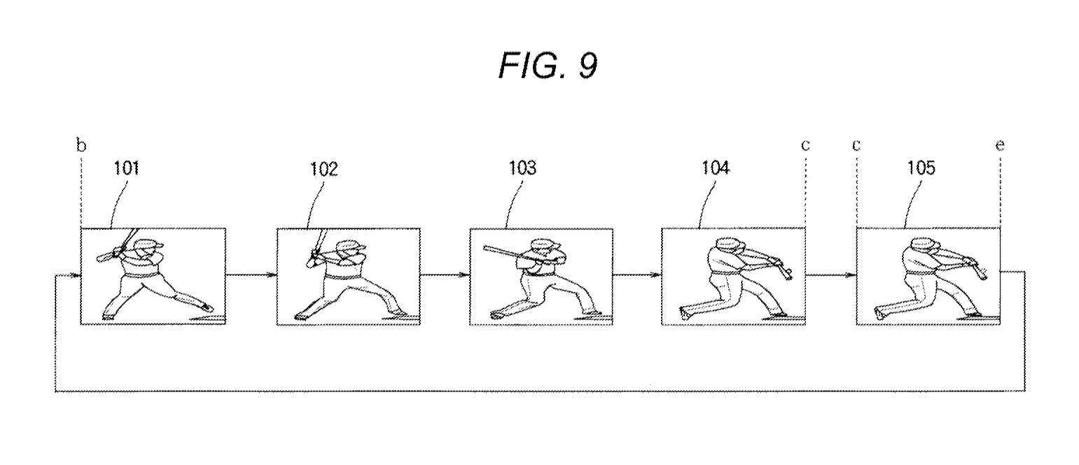

Referring to FIG. 9, when the browsing unit #1 includes frames 101 to 104, the same frame as the frame 104 which is the last frame of the browsing unit #1 is a frame 105 of the browsing unit #2. Hence, when the browsing unit #1 and the browsing unit #2 are continuously played back, the frame 104 and the frame 105 of the same image are continuously played back. Subsequently, playback is returned to the frame 101 again, and then subsequent frames are played back. In this case, loop playback of a movie including the frames 101 to 105 is performed.

To the user side, one movie including the frames 101 to 105 seems to be repeatedly played back. However, the movie actually includes two browsing units of the browsing unit #1 and the browsing unit #2.

Thus, upon loop playback of the browsing unit #1, by providing the browsing unit #2 including a copy of the last one frame of the browsing unit #1 and providing the play item #2 for managing the browsing unit #2, it is possible to perform loop playback of the browsing unit #1.

Thus, a stream related to a video image includes the browsing unit #1 and the browsing unit #2. Further, in this case, the browsing unit #2 is a browsing unit which includes part of the browsing unit #1 (for example, the last one frame). Furthermore, the browsing unit #2 is played back after the browsing unit #1 is played back, a transition to playback from the top of the browsing unit #1 is made after the browsing unit #2 is played back, so that loop playback of the browsing unit #1 is realized.

Still further, a stream related to a video image including the browsing unit #1 and the browsing unit #2 is played back out of synchronization with a sound stream. Consequently, even when the stream related to the video image is switched, the sound stream can be continuously played back without being switched and a video image can be switched while a sound is not interrupted.

To enable this, when the browsing unit #1 is a browsing unit which is a loop playback target, the browsing unit #2 is prepared as a loop playback browsing unit for performing loop playback of the browsing unit #1.

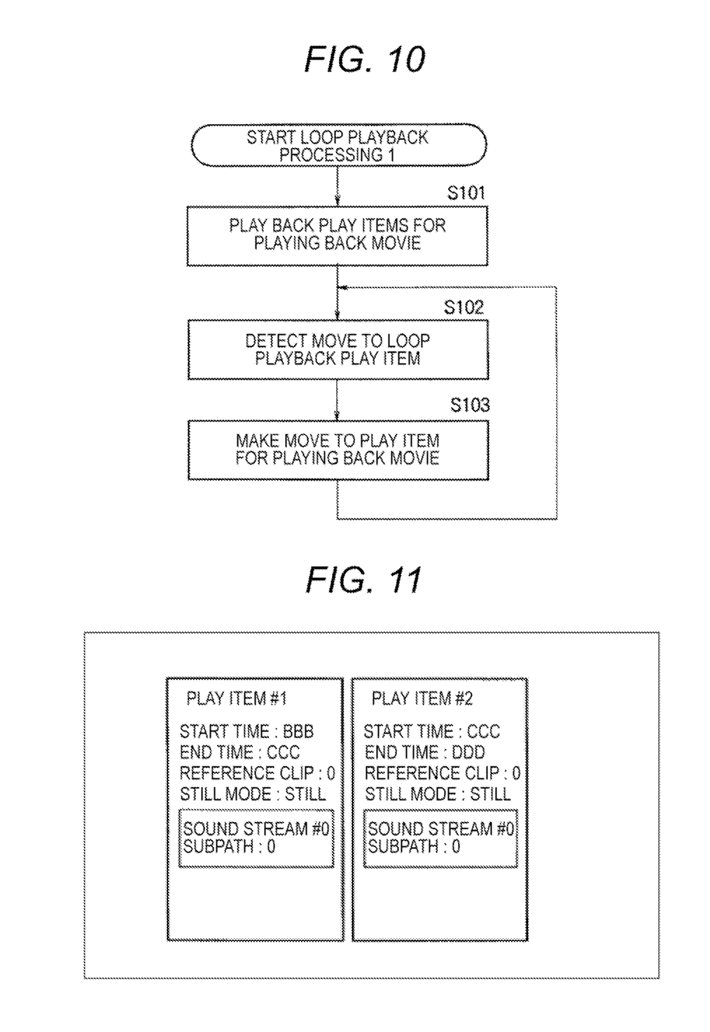

Processing which is executed where there are the play item #1, the play item #2, the browsing unit #1 and the browsing unit #2 and executes loop playback of the browsing unit #1 will be described with reference to the flowchart in FIG. 10. Processing according to the flowchart illustrated in FIG. 10 is described as a BD-J (Blu-ray Disc Java (registered trademark)) program, and is recorded in a recording medium such as a blu-ray disc driven by the medium driving unit 29 (FIG. 3). Further, the medium driving unit 29 drives this disc, the program is read and stored in the memory 23 and the control unit 22 executes processing based on this stored program to start this program.

In step S101, a play item for playing back a movie is played back. In this case, playback of the play item #1 (FIG. 5) is started, and playback from the top of the browsing unit #1 is started. A start time of the play item #1 is “BBB”, and a clip position of the time “BBB” is read as “b” from information of the feature points of the clip information #0. Further, playback from the clip position “b” of the clip file #0 is started.

In this case, the play item #1 is played back, and then the subpath #0 is referred to for the sound stream. Further, a reference clip described in the subpath #0 is “1”, and therefore the clip information #1 is referred to and the clip file #1 is played back. Thus, separate clip files of the video image and the voice are independently played back and are provided to the user.

In step S102, a stand-by mode is maintained until a move to a loop playback play item is made. That is, in this case, playback of the play item #1 is continued until a move to the play item #2 is made. The still mode of the play item #1 is set to “no”, the end time is “CCC” and a clip position at the time “CCC” is “c”.

Hence, when playback proceeds to the position “c” of the clip file #0, a move to the play item #2 is made. When a move from the play item #1 to the play item #2 is detected, processing moves to step S103. The BD-J program is configured to be able to perform this detection.

In step S103, a move to a play item for playing back a movie is made. The play item for playing back the movie is the play item #1, and a move from the play item #2 to the play item #1 is made. When the move to the play item #1 is made, playback from the clip position “b” of the clip file #0 is started as described above. That is, playback from the top of the play item #1 is started again.

Thus, while playback based on the play item #1 is performed, processing in step S102 is performed and, when a move to the play item #2 is detected, processing in step S103 is performed. When processing in step S102 and step S103 is repeated, the play item #1 is repeatedly played back, and the movie to be played back based on the play item #1 is repeatedly played back.

Thus, when the still mode of the play item #1 for playing back the browsing unit #1 is set to a mode which commands a transition to a next play item, if a transition of playback from the browsing unit #1 to the browsing unit #2 is detected, a transition to playback of the browsing unit #1 is made, so that loop playback of the browsing unit #1 is realized.

Thus, loop playback of a predetermined movie is performed.

[Still Mode is Set to Still]

Although the still mode of the play item #1 is set to “no” in the above embodiment, even when the still mode is set to “still”, loop playback can be played back. Next, a case where the still mode is set to “still” will be described. FIG. 11 illustrates the play item #1 and the play item #2. Except that the still mode of the play item #1 is described as “still”, the same content as that of the play item #1 illustrated in FIG. 5 is described. Further, the play item #2 illustrated in FIG. 11 has the same content as that of the play item #2 illustrated in FIG. 5.

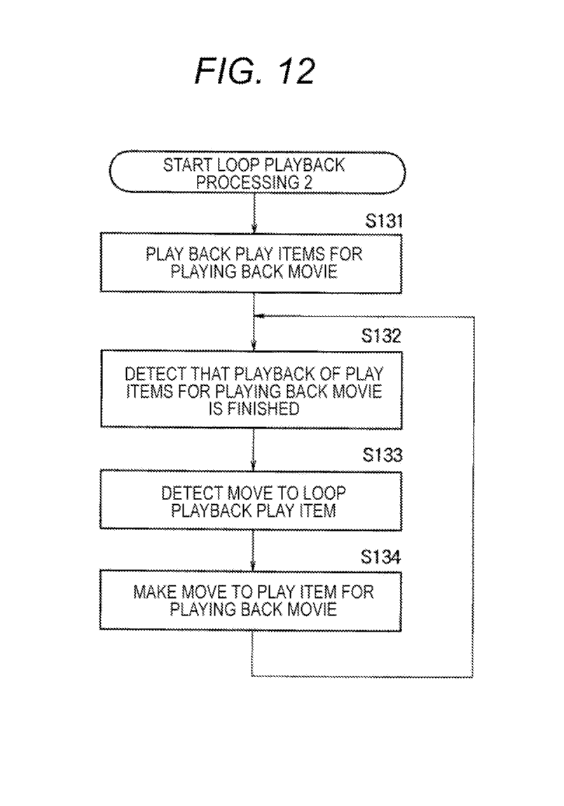

When loop playback of the play item #1 is performed based on these play item #1 and play item #2, processing based on processing according to the flowchart illustrated in FIG. 12 is performed. Similar to the processing according to the flowchart illustrated in FIG. 10, processing according to the flowchart illustrated in FIG. 12 is also described as a BD-J program, and is recorded in a recording medium such as a blu-ray disc driven by the medium driving unit 29 (FIG. 3).

In step S131, a play item for playing back a movie is played back. In this case, the play item #1 illustrated in FIG. 11 is played back. The processing in this step S131 is performed in the same way as the processing in step S101 according to the flowchart illustrated in FIG. 10.

In step S132, a stand-by state is maintained until playback of the play item for playing back the movie is finished. That is, in this case, until playback of the play item #1 is finished, playback processing of the play item #1 is maintained. As illustrated in FIG. 11, the still mode of the play item #1 is set to “still”, the end time is “CCC” and a clip position at the time “CCC” is “c”.

Hence, when playback proceeds to the position “c” of the clip file #0, playback is temporarily stopped. When such playback of the play item #1 is finished, and a state of temporary stop starts and is detected, and processing moves to step S133. The BD-J program is configured to be able to perform this detection. When it is detected that playback of the play item #1 is finished and processing moves to step S133, a move to the loop playback play item is made. In this case, the loop playback play item is the play item #2, and a move to the play item #2 is made.

When the move to the loop playback play item is detected, processing moves to step S134. The BD-J program is configured to be able to perform this detection. In step S134, a move to a play item for playing back a movie is made. The play item for playing back the movie is the play item #1, and a move from the play item #2 to the play item #1 is made. When the move to the play item #1 is made, playback from the clip position “b” of the clip file #0 is started as described above. That is, playback from the top of the play item #1 is started again.

Thus, when the still mode of the play item #1 for playing back the browsing unit #1 is set to a mode which commands temporary stop, that playback based on the play item #1 is finished is detected and a move to the play item #2 is detected, so that the play item #1 and the play item #2 are repeatedly played back. Thus, loop playback of a predetermined movie is performed.

[Loop Playback Using Common Play Item]

A case has been described with the above embodiment where a play item (play item #1) whose loop playback needs to be performed and a loop playback play item (play item #2) have a one-to-one relationship. Next, a case will be described as an example where there is one loop playback play item for a plurality of play items whose loop playback needs to be performed.

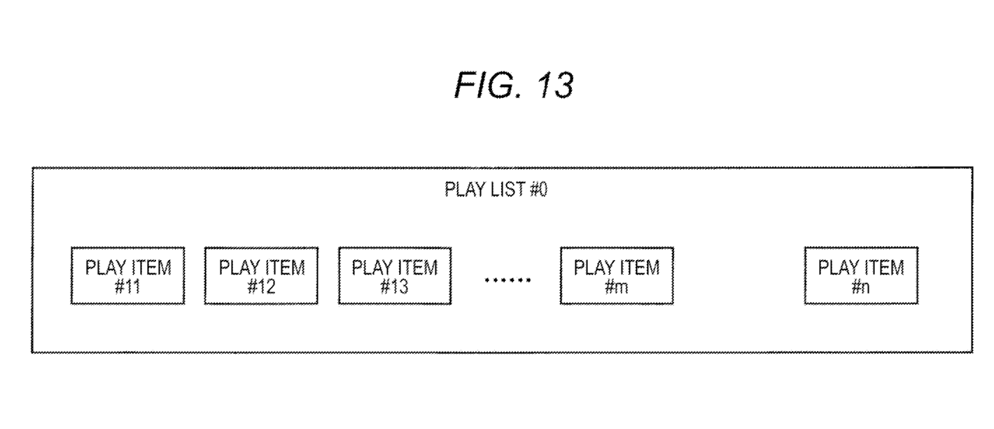

FIG. 13 is a view illustrating a configuration of a playlist when there is a plurality of play items which are loop playback targets and one loop playback play item. The play item #0 illustrated in FIG. 13 includes a play item #11, a play item #12, a play item #13, . . . a play item #m and a play item #n. The play item #11 to #m are play items of a movie which are loop playback targets. The play item #n is a loop playback play item and is, for example, a play item for playing back a black still image.

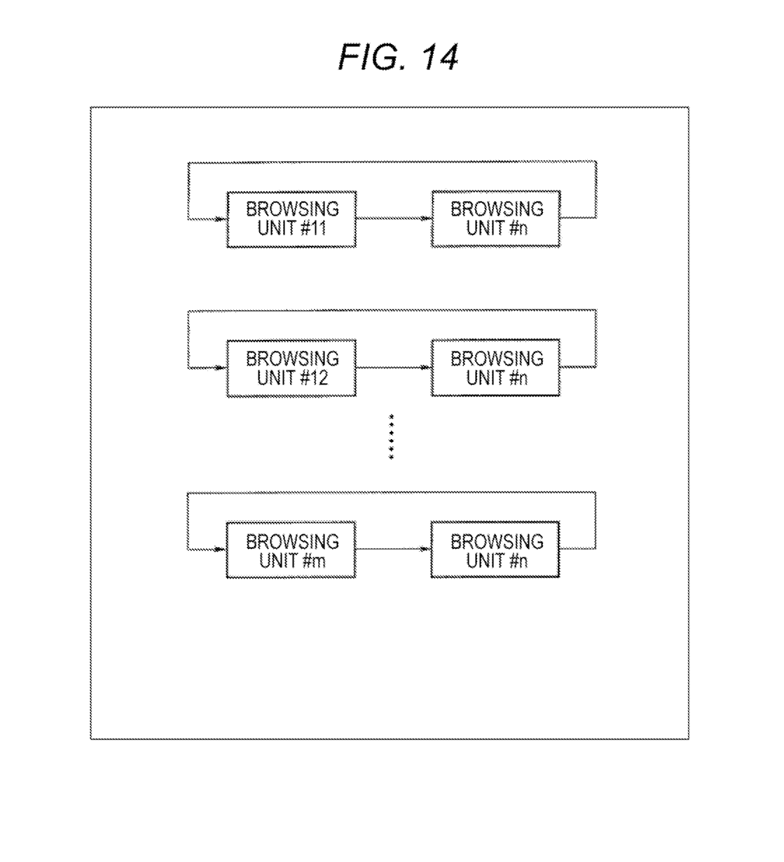

A configuration of a video stream upon playback of the playlist #0 will be described with reference to FIG. 14. In FIG. 14, the browsing unit #11 is a browsing unit managed by the play item #11, the browsing unit 12 is a browsing unit managed by the play item #12, . . . , and the browsing unit #m is a browsing unit managed by the play item #m.

Referring to FIG. 14, when the browsing unit #11 is a loop playback target, the movie of the browsing unit #11 is played back and, when playback of the movie is finished, a transition to playback of the browsing unit #n is made. The browsing unit #n is a black still image, and a black screen is temporarily provided to the user. The browsing unit #n is played back and playback is returned to the top of the browsing unit #11, so that the movie of the browsing unit #11 is provided to the user again.

Similarly, when the browsing unit #12 is a loop playback target, the movie of the browsing unit #12 is played back and, when playback of the movie is finished, a transition to playback of the browsing unit #n is made. Also in this case, the browsing unit #n is a black still image, and a black screen is temporarily provided to the user. The browsing unit #n is played back and playback is returned to the top of the browsing unit #12, so that the movie of the browsing unit #12 is provided to the user again.

Similarly, when the browsing unit #m is a loop playback target, the movie of the browsing unit #m is played back and, when playback of the movie is finished, a transition to playback of the browsing unit #n is made. Also in this case, the browsing unit #n is a black still image, and a black screen is temporarily provided to the user. The browsing unit #n is played back and playback is returned to the top of the browsing unit #m, so that the movie of the browsing unit #m is provided to the user again.

Thus, when the browsing units #11 to #m are a plurality of browsing units which is a loop playback target, and one of the browsing units is a loop playback target, the browsing unit #n is a loop playback browsing unit which is commonly used by a plurality of browsing units.

Thus, playback is performed such that playback transitions from a loop playback browsing unit to the browsing unit #n and a jump is performed from the browsing unit #n to the top of the original browsing unit. By so doing, one loop playback browsing unit can be shared by a plurality of browsing units. Sharing the browsing unit is effective when, for example, the number of play items which can be included in the play list #0 (FIG. 13) is limited.

That is, when play items of a movie which are loop playback targets and loop playback play items are prepared on a one-on-one basis, the number of play items is great, the number of play items exceeds a limitation value and the play items are not likely to be included in one play list #0. However, by sharing a loop playback play item, the number of loop playback play items can be reduced, so that it is possible to include more play items of a movie which are loop playback targets in the play list #0.

Thus, also when the common loop playback play item #m is provided, processing related to loop playback is performed based on the flowchart illustrated in FIG. 10 or FIG. 12 and therefore will not be described.

Thus, it is possible to repeatedly playback a movie while independently playing back a movie and voices, and continue playback while the voices are not interrupted. When, for example, a movie is recorded in a recording medium, there is a screen to select and playback a chapter, and it is possible to repeatedly display a movie of the selected chapter in the background in this screen while outputting a BGM (voice).

Further, this is also applicable even when a shopping application is realized using a recording medium such as a Blu-ray disc. For example, when a movie of a product is repeatedly played back while emitting a BGM, it is possible to switch a movie of a product according to a user's operation. Moreover, the BGM continues as is, so that it is possible to prevent the user from losing an interest in the product due to an interruption of the BGM.

[Recording Medium]

The above series of processing can be executed by hardware or can be executed by software. When a series of processing is executed by software, the program which configures this software is installed in a computer. Meanwhile, the computer includes a computer which is embedded in dedicated hardware or a general-purpose personal computer which can execute various functions by installing various programs.

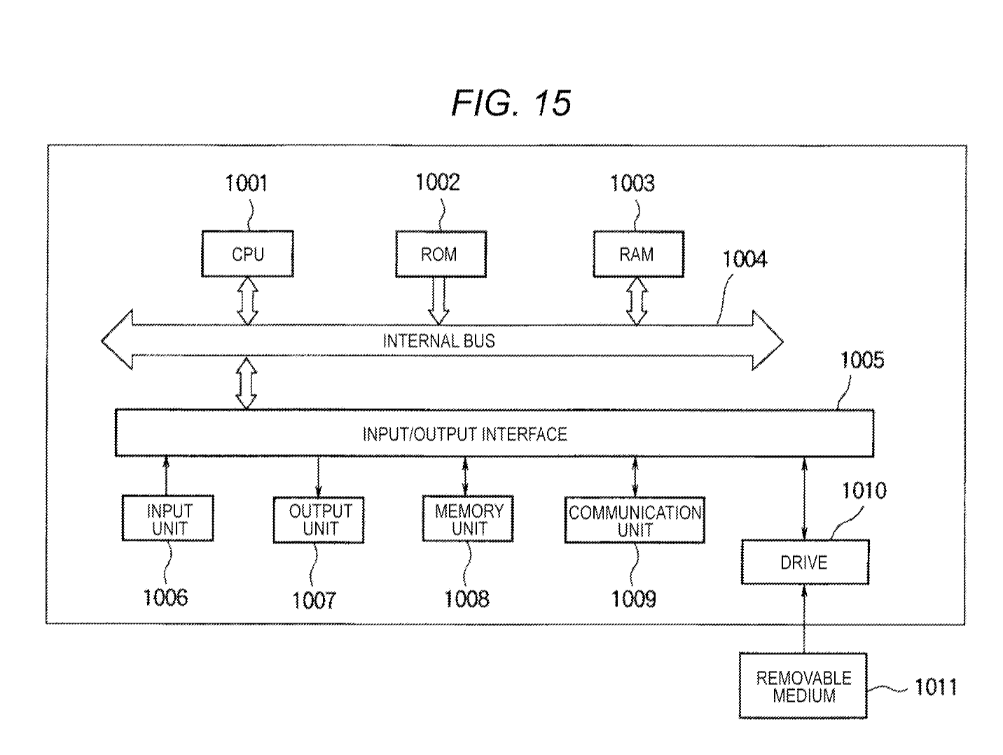

FIG. 15 is a block diagram illustrating a configuration example of hardware of the computer which executes the above series of processing by a program. In the computer, a CPU (Central Processing Unit) 1001, a ROM (Read Only Memory) 1002 and a RAM (Random Access Memory) 1003 are connected with each other through a bus 1004. The bus 1004 is further connected with an input/output interface 1005. The input/output interface 1005 is connected with an input unit 1006, an output unit 1007, a memory unit 1008, a communication unit 1009 and a drive 1010.

The input unit 1006 includes a keyboard, a mouse and a microphone. The output unit 1007 includes a display and a speaker. The memory unit 1008 is a hard disk or a non-volatile memory. The communication unit 1009 is a network interface. The drive 1010 drives a removable medium 1011 such as a magnetic disk, an optical disk, a magnet-optical disk or a semiconductor memory.

In the computer configured as described above, for example, the CPU 1001 loads the program stored in the memory unit 1008, to the RAM 1003 through the input/output interface 1005 and the bus 1004 to perform the above series of processing.

For example, the program to be executed by the computer (CPU 1001) can be recorded in the removable medium 1011 such as a package medium and provided. Further, the program can be provided through a wired or wireless transmission medium such as a local area network, the Internet or digital satellite broadcasting.

In the computer, the program can be installed in the memory unit 1008 through the input/output interface 1005 by attaching the removable medium 1011 to the drive 1010. Further, the program can be received at the communication unit 1009 through the wired or wireless transmission medium and installed in the memory unit 1008. In addition, the program can be installed in advance in the ROM 1002 or the memory unit 1008.

In addition, the program to be executed by the computer may be a program which executes processing in time series in order described in this description or may be a program which executes processing in parallel or at a necessary timing such as a time when the program is invoked.

Further, in this description, a system refers to an entire apparatus which is formed with a plurality of apparatuses.

In addition, the embodiment of the present technique is not limited to the above embodiment, and can be variously changed in a range which does not deviate from the scope of the present technique.

In addition, the present technique can also employ the following configuration.

(1)

A playback apparatus has a playback unit which plays back a first stream and a second stream out of synchronization, and

the first stream has a first browsing unit and a second browsing unit,

the second browsing unit is a browsing unit which includes part of the first browsing unit and

the playback unit plays back the second browsing unit after playing back the first browsing unit, and makes a transition to playback from a top of the first browsing unit after playing back the second browsing unit.

(2)

In the playback apparatus described in (1), the first stream is a video image, and the second stream is a sound.

(3)

In the playback apparatus described in (1) or (2),

the first browsing unit is a browsing unit which is a loop playback target, and

the second browsing unit is a loop playback browsing unit.

(4)

In the playback apparatus described in any of (1) to (3),

a still mode of a play item for playing back the first browsing unit is set to a mode which commands a transition to a next play item, and

the playback unit makes a transition to playback of the first browsing unit when detecting a transition of playback from the first browsing unit to the second browsing unit.

(5)

In the playback apparatus described in any of (1) to (3),

a still mode of a play item for playing back the first browsing unit is set to a mode which commands temporary stop, and

the playback unit makes a transition to playback of the second browsing unit when detecting that playback of the first browsing unit is finished and a state of temporary stop starts, and makes a transition to playback of the first browsing unit when detecting a transition to playback of the second browsing unit.

(6)

In the playback apparatus described in any of (1) to (5),

the first browsing unit is one browsing unit of a plurality of browsing units which is a loop playback target, and

the second browsing unit is a loop playback browsing unit which is commonly used by the plurality of browsing units.

(7)

With a playback method of a playback apparatus which has a playback unit which plays back a predetermined stream,

a first stream has a first browsing unit and a second browsing unit,

the second browsing unit is a browsing unit which includes part of the first browsing unit, and

the method includes the steps of, at the playback unit,

playing back the first stream and a second stream out of synchronization; and

playing back the second browsing unit after playing back the first browsing unit, and making a transition to playback from a top of the first browsing unit after playing back the second browsing unit.

(8)

With a computer-readable program,

a first stream has a first browsing unit and a second browsing unit,

the second browsing unit is a browsing unit which includes part of the first browsing unit, and

the program causes a computer which controls a playback apparatus which has a playback unit which plays back a predetermined stream to execute processing including the steps of, at the playback unit,

playing back the first stream and a second stream out of synchronization and

playing back the second browsing unit after playing back the first browsing unit, and making a transition to playback from a top of the first browsing unit after playing back the second browsing unit.

### REFERENCE SIGNS LIST

10 Playback apparatus, 21 Operation unit, 22 Control unit, 23 Memory, 24 ROM, 25 Video stream buffer, 26 Video image decoder, 27 Voice stream buffer, 28 Voice decoder, 29 Medium driving unit, 30 Image/sound output unit

1. A playback apparatus comprising:
a playback unit which plays back a first stream and a second stream out of synchronization, wherein:
the first stream comprises a first browsing unit and a second browsing unit;
the second browsing unit is a browsing unit which includes part of the first browsing unit; and
the playback unit plays back the second browsing unit after playing back the first browsing unit, and makes a transition to playback from a top of the first browsing unit after playing back the second browsing unit.

2. The playback apparatus according to claim 1, wherein: the first stream is a video image; and the second stream is a sound.

3. The playback apparatus according to claim 1, wherein:
the first browsing unit is a browsing unit which is a loop playback target; and
the second browsing unit is a loop playback browsing unit.

4. The playback apparatus according to claim 1, wherein:
a still mode of a play item for playing back the first browsing unit is set to a mode which commands a transition to a next play item; and
the playback unit makes a transition to playback of the first browsing unit when detecting a transition of playback from the first browsing unit to the second browsing unit.

5. The playback apparatus according to claim 1, wherein:
a still mode of a play item for playing back the first browsing unit is set to a mode which commands temporary stop; and
the playback unit makes a transition to playback of the second browsing unit when detecting that playback of the first browsing unit is finished and a state of temporary stop starts, and makes a transition to playback of the first browsing unit when detecting a transition to playback of the second browsing unit.

6. The playback apparatus according to claim 1, wherein:
the first browsing unit is one browsing unit of a plurality of browsing units which is a loop playback target; and
the second browsing unit is a loop playback browsing unit which is commonly used by the plurality of browsing units.

7. A playback method of a playback apparatus which comprises a playback unit which plays back a predetermined stream, wherein:
a first stream comprises a first browsing unit and a second browsing unit;
the second browsing unit is a browsing unit which includes part of the first browsing unit; and
the playback method comprises the steps of, at the playback unit,
playing back the first stream and a second stream out of synchronization; and
playing back the second browsing unit after playing back the first browsing unit, and making a transition to playback from a top of the first browsing unit after playing back the second browsing unit.

8. A computer-readable program, wherein:
a first stream comprises a first browsing unit and a second browsing unit;
the second browsing unit is a browsing unit which includes part of the first browsing unit; and
the program causes a computer which controls a playback apparatus which comprises a playback unit which plays back a predetermined stream to execute processing comprising the steps of, at the playback unit,
playing back the first stream and a second stream out of synchronization; and
playing back the second browsing unit after playing back the first browsing unit, and making a transition to playback from a top of the first browsing unit after playing back the second browsing unit.
